(19) United States
(12) Patent Application Publication
(10) Pub. No.: US 2008/0110744 A1
(43) Pub. Date: May 15, 2008

(54) Method for the Preparation of a Gas or Mixture of Gases Containing Molecular Fluorine

(76) Inventors: Jean-Marc Girard, Paris (FR); Herve E. Dulphy, Jarrie (FR); Jean-Christophe Rostaing, Versailles (FR); Pascal Moine, Groisy (FR)

Correspondence Address: AIR LIQUIDE;Intellectual Property, 2700 POST OAK BOULEVARD, SUITE 1800, HOUSTON, TX, 77056, US

(21) Appl. No.: 11/570,111

(22) PCT Filed: Jun. 26, 2005
(86) PCT No.: PCT/FR05/01652

§ 371 Date: Jan. 10, 2008

(30) Foreign Application Priority Data
Jun. 30, 2004 (FR) 0451378
Jun. 30, 2004 (FR) 0451379
Jun. 21, 2005 (FR) 0551676

(51) Int. Cl. B01D 53/32; C25D 17/00

(52) U.S. Cl. 204/157.3; 204/194

(57) ABSTRACT

A method and device for the preparation of a gas or mixture of gases containing molecular fluorine from a gas or mixture of gases derived from fluorine, wherein the fluorinated gas or mixture of gases, particularly nitrogen trifluoride NF₂, is decomposed by cracking in a plasma of molecules of fluorinated gases in order to produce a mixture of atomic fluorine and other species resulting form said cracking, whereupon said mixture is subsequently cooled in a rapid manner (24), if necessary at a temperature of less than 500° C., in order to result in the formation of molecular fluorine of rat least 50% atomic fluorine thus formed and to minimize the recombination of fluorine atoms with other products arising from said cracking and to reform a fluorinated gas or mixture of gases, wherein the gaseous mixture containing F₂ is recovered.

The present invention relates to a method for preparing a gas or gas mixture containing molecular fluorine.

The cleaning of equipment for producing semiconductors and particularly film or etching deposition chambers is becoming more and more difficult. Increasing use is therefore made of fluorine F₂ as a cleaning agent. The storage of fluorine in cylinders on a semiconductor production site is a delicate matter because, due to the physical properties of the fluorine, the quantities that can be stored in a compressed gas cylinder are excessively small, compared with the quantities required for these cleaning operations. Moreover, for obvious safety reasons, it is inconceivable, at the present time, to store this product in bulk or in large quantities on a semiconductor production site. This is why fluorine is still little used today in semiconductor production units for cleaning purposes.

U.S. Pat. No. 5,788,775 or U.S. Pat. No. 5,812,403 teaches the use of nitrogen trifluoride NF₃ for cleaning single wafer process chambers, with an external plasma generator, for example for the various CVD processes such as CVD-SiO₂, SiN-CVD, SiC-CVD, SiOC-CVD and W-CVD. In this cleaning process, F radicals (atomic fluorine) are formed by a microwave argon+NF₃ (+He) plasma, at a reduced pressure of about 1 to 5 torr. The plasma generator is positioned as close as possible to the chamber in order to minimize the recombination of the F radicals. Cleaning is obtained by the reaction of F radicals with the deposits on the walls of the process chamber, at a temperature close to ambient temperature, producing volatile species such as SiF₄, WF₆ and CF₄. This process uses NF₃ or F₂ as a source of fluorine F radicals to clean the process chamber.

Reference can also be made to the article entitled “Production of fluorine-containing molecular species in plasma-generated Atomic F. Flows” by G. J. Stuebar et al published in Journal de Phys. Chem. A. (2002, 107, 7775-7782).

However, this technique is difficult to incorporate in wafer ovens comprising a large number of wafers simultaneously in the oven. For these wafer ovens, thermal cleaning processes are preferred. Furthermore, such a process makes equivalent use of fluorine F₂ and nitrogen trifluoride NF₃.

It was recently suggested to use fluorine, pure or in a mixture, as a thermal cleaning gas, in situ, for multiple wafer ovens. In such a method, the fluorine F₂ molecules are thermally decomposed.

However, the storage of F₂ on a semiconductor production site is a very delicate matter due to the local safety requirements, the maximum pressure F₂ authorized in the cylinders, transport regulations, etc.

In consequence, other alternatives have been explored for supplying F₂ on site. Technically, the solution of the electrolysis of KF—HF molten salts has been established (for further details about such a technological solution, reference can be made to patent applications . . . ). Although theoretically simple, the method actually has drawbacks such as the need to store the fluorine produced in buffer tanks because the flow rate of F₂ needed for cleaning is much higher than an electrolysis cell of reasonable size can produce. Furthermore, the complexity of the system, which comprises automatic supply of liquid HF, as well as the separation of HF gas from F₂ gas, is an obstacle to the industrial use of such a process.

Japanese patent application JP04-323377 to Hitachi Electronics Eng. Co. describes a cold atmospheric discharge system (corona vapor or dielectric barrier discharge) in which NF₃ is decomposed to generate atomic fluorine F. However, due to the low electron density in the discharge, such a system produces a low dissociation rate of about a few percent, with the experimental result of obtaining a mixture containing no more than 5% by volume of atomic fluorine, which must be contacted immediately with the wall to be cleaned.

U.S. Pat. No. 4,213,102 also teaches the thermal decomposition of NF₃ to generate atomic fluorine F and molecular fluorine F₂. However, the experiment shows that the thermal decomposition of the NF₃ molecules is very incomplete and that less than 50% of the NF₃ molecules are decomposed. Moreover, it has been found that during the cooling of such a mixture, NF₃ molecules were essentially formed, thus leading to the production of a mixture mainly containing NF₃.

The inventive method does not have the drawbacks of the solutions mentioned above and is much simpler to implement. It is characterized in that the fluorine-containing gas or gas mixture, particularly nitrogen trifluoride NF₃, is decomposed by passage through a hot high electron density plasma, a plasma generated at atmospheric pressure or close to atmospheric pressure, in order to obtain a maximum temperature Tₘₐₓ higher than 2000 K of the heavy species (other than electrons) in the plasma; the mixture of the various species present in the plasma is then cooled to a temperature Tₕ, then rapidly cooled between Tₕ and T_{b}, Tₕ and T_{b} being respectively two temperatures determined experimentally according to the fluorine-containing gas or gas mixture, Tₕ being the temperature from which the molecules of fluorine-containing gas or gas mixture tend to recombine into molecules of gas initially injected into the plasma, and T_{b} being the temperature at which over 90% of the fluorine atoms produced by the dissociation in the plasma of the fluorine-containing gas or gas mixture have recombined, thereby serving to obtain a gas mixture containing 50 vol % of molecular fluorine F₂.

Preferably, the inventive method is characterized in that the maximum temperature of the heavy species in the discharge generating the plasma is between 3000 K and 10 000 K. Also preferably, the electron density of the plasma is higher than 10¹² electrons/cm³, preferably between 10¹² and 10¹⁵ electrons/cm³.

According to an alternative embodiment of the invention, the method is characterized in that the rapid cooling time between the temperatures Tₕ and T_{b} is shorter than 5×10⁻² to prevent a substantial reformation of the initial species and to promote the formation of fluorine molecules F₂. Preferably, this rapid cooling time is shorter than 10⁻² seconds, preferably shorter than 5×10⁻³ seconds.

According to the invention, the preferred fluorine-containing gas is nitrogen trifluoride NF₃, Tₕ being about 1200 K and T_{b} being about 800 K.

According to another feature of the invention, preferably, the plasma is a plasma close to thermodynamic equilibrium and particularly a plasma generated by radiofrequency waves or microwaves.

Atmospheric pressure here means a pressure close to atmospheric pressure, varying between 10⁴ and 10⁶ pascals.

It is possible, for example, to use NF₃ stored in a pressurized cylinder and expanded before or during its entry into the plasma region. The fluorine-containing gas or gas mixture can also be injected using a “vortex” type of injection system as described in French patent application No. 04 5127 in the name of the applicant and incorporated here for reference. In particular, this type of injection, in which the gas is injected with a velocity component not parallel to the axis is advantageous, particularly (but not exclusively) during low flow rates of gas of the NF₃ type, when fluorine is generated for cleaning vapor deposition reactors. Thus this flow rate of fluorine-containing gas (alone or in a mixture) can be lowered to a value of between 2 and 60 liters/min (for example, up to 21/min for NF₃). In this type of system with “vortex”, the fluorine-containing gas or gases can be injected under pressure generally up to about 7×10⁵ pascals (7 bar). In using this technique, it is preferable to carry out one or more injections of fluorine-containing gas “downward” (with regard to a plasma created in a vertically placed tube) because an improvement is thereby observed in the centering of the resulting plasma around the tube axis, making it possible to preserve a distance between the plasma and the tube walls, thereby avoiding local overheating (at the contact points) of said tube.

According to the invention, it has been found that after dissociation of the molecules of fluorine-containing gas, generally making it possible to generate atomic fluorine if the temperature is sufficiently high, it was important, within a certain gas temperature range, of between about 1200 K (Tₕ) and 800 K (T_{b}) (or at least in part thereof) to rapidly cool the mixture of species issuing from the plasma.

Rapid here means a cooling time between Tₕ and T_{b} not longer than about 5×10⁻² seconds, to prevent a substantial reformation of the initial species and thereby promote the formation of molecules of fluorine F₂. This duration is preferably shorter than 10⁻² s, and more preferably shorter than 5×10⁻³ s.

During the decomposition cycle of the fluorine-containing molecules, particularly NF₃, the temperature of the gas or gas mixture containing this fluorine-containing gas is generally raised rapidly in order to dissociate the molecules of fluorine-containing gas and reach a plasma temperature Tₘₐₓ of up to 10 000 K, and which is preferably always higher than Tₕ (where Tₕ is a temperature of about 1200 K for NF₃ and which can be determined experimentally for other species). The gas mixture is then cooled from Tₘₐₓ to Tₕ at a rate that generally has little influence on the formation of the F₂ or NF₃ molecules or of the initial fluorine-containing gas. As soon as this temperature Tₕ is reached (average temperature of the mixture issuing from the plasma), and no later, the mixture is cooled rapidly to at least T_{b} or a temperature below T_{b} (generally about 800 K), that is, for example, by quenching the mixture issuing from the plasma by heat exchange between the mixture and a cold zone, for example a cold wall, a cold gas or any other means.

The invention also relates to a fluorine-containing gas generator delivering a gas containing molecular fluorine, and comprising a source of fluorine-containing gas, such as nitrogen trifluoride NF₃, means for generating a hot high electron density plasma to decompose the fluorine-containing gas molecules and to generate a plasma at a maximum temperature for the heavy species Tₘₐₓ equal to 2000 K or higher, means for cooling the gas mixture produced by this decomposition, and means for recovering the gas mixture containing the molecules of fluorine F₂ after cooling to a temperature below T_{b}.

The generator for implementing the inventive method can also comprise means for diluting the gas mixture before, during and/or after the decomposition by cracking of the fluorine-containing gas, and the gases recovered, which contain fluorine, can be contacted with a surface or a volume; the surface or volume is made from metal or polymer; the gas or gas mixture derived from fluorine can be mixed previously with a first preferably inert gas (prior to the cracking step); the mixture can be diluted with a second gas, particularly an inert gas, during or after cracking of the mixture; the temperature of the second gas is such that, for example, it serves to at least partially carry out the rapid cooling step that may be necessary to promote the formation of molecular fluorine; after cooling, the gas mixture can be mixed with a third preferably inert gas; the first, second, or third gas is selected from nitrogen, argon, helium, krypton, xenon, CO₂, CO, NO, hydrogen, alone or in mixtures thereof; the gas mixture comprises 75 mol % to 1 ppm of molecular fluorine F₂. When the cooling is carried out by passing the mixture issuing from the plasma through an oil heat exchanger, use is made of a cooling oil that does not react with fluorine.

The plasma may, for example, be relatively close to thermodynamic equilibrium, so that the thermal effects play a significant but not exclusive role in the decomposition of the fluorine-containing gas, for example, nitrogen trifluoride, as in the case, for example, of a microwave plasma, or an inductively coupled plasma (ICP).

The rapid cooling is preferably carried out very rapidly in the form of a quench, while the plasma is preferably cooled to a temperature equal to 800 K or lower. For example, this quench can be carried out by passage through a heat exchanger cooled, for example, with an oil that does not react with fluorine, in order to avoid any safety problems, even if the two products are not in contact with one another in principle.

The gas or gas mixture derived from fluorine (preferably NF₃) can be mixed with an inert gas such as nitrogen and/or argon in particular, before being subjected to the cracking step.

The mixture is diluted with a gas, particularly an inert gas such as nitrogen and/or argon, before the rapid cooling step.

The rapid cooling step can be carried out using a gas, preferably a cold gas injected in contact with the mixture to carry out a gas quench of said mixture.

In one alternative, the gas mixture after cooling is mixed with an inert gas, particularly nitrogen and/or argon, and sent to the vessel to be treated.

The gas mixture containing fluorine is preferably cracked using the above means in order to produce atomic fluorine.

In particular, the fluorine-containing gas mixture is cracked by passage through a plasma maintained by a discharge resulting from an electromagnetic field, called a “hot” plasma in the definition well known to a person skilled in the art.

The invention will be better understood from the following exemplary embodiments, provided as nonlimiting examples, with reference to the figures appended hereto which show:

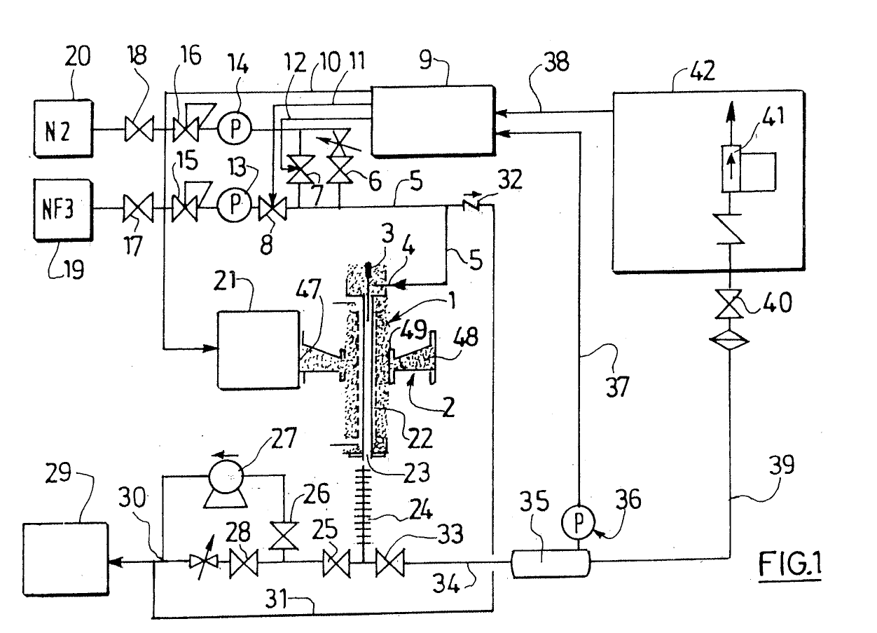

FIG. 1, a schematic representation of the inventive device and method, with pressure control;

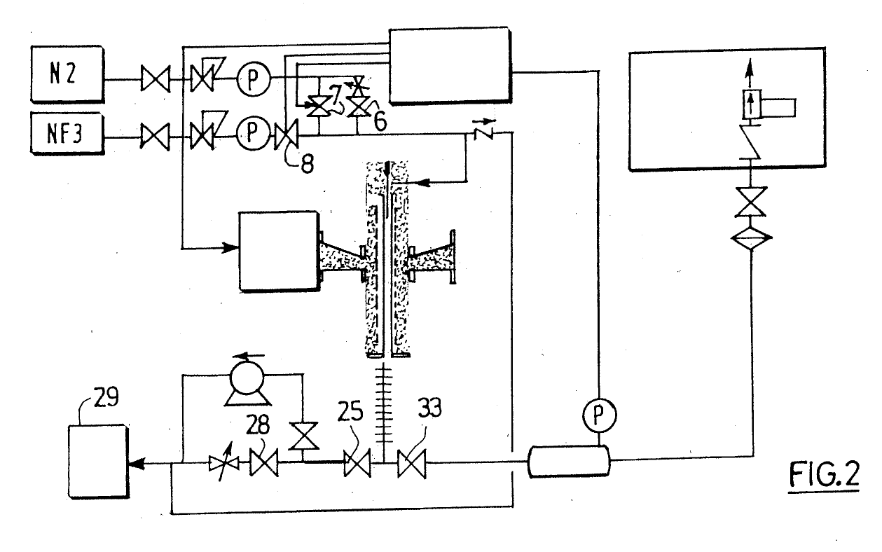

FIG. 2, an alternative of FIG. 1, in a fluorine flow mode;

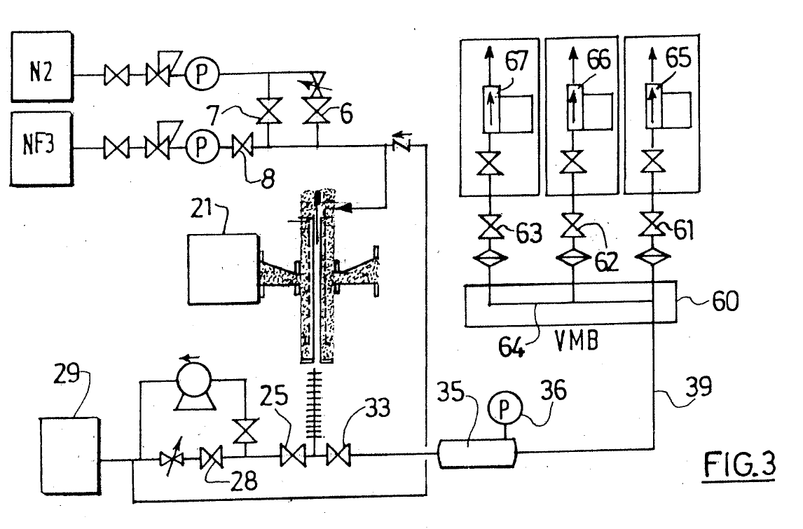

FIG. 3, an alternative of FIG. 2, with simultaneous fluorine supply to a plurality of apparatus;

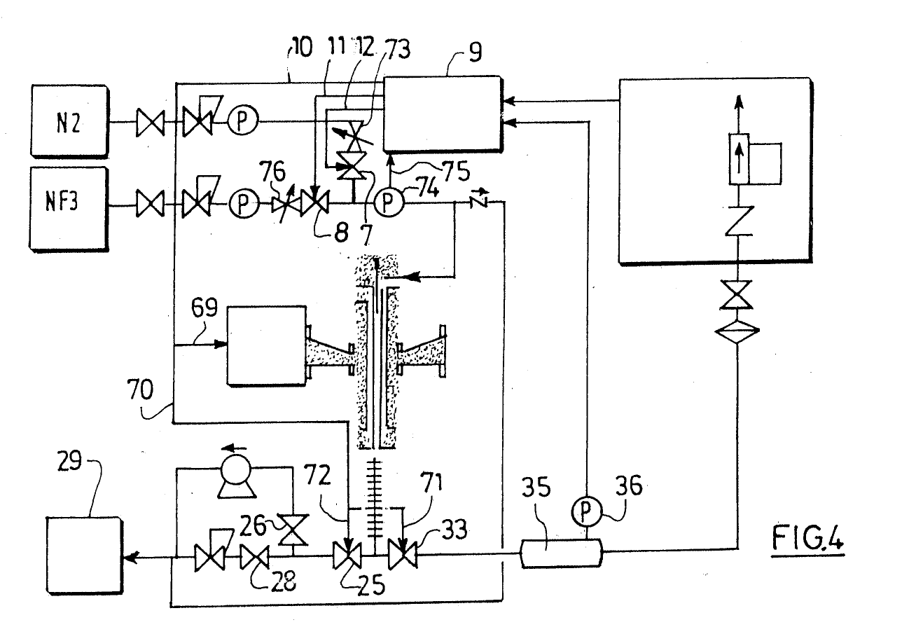

FIG. 4, an alternative of FIG. 1, with flow control by calibrated orifices;

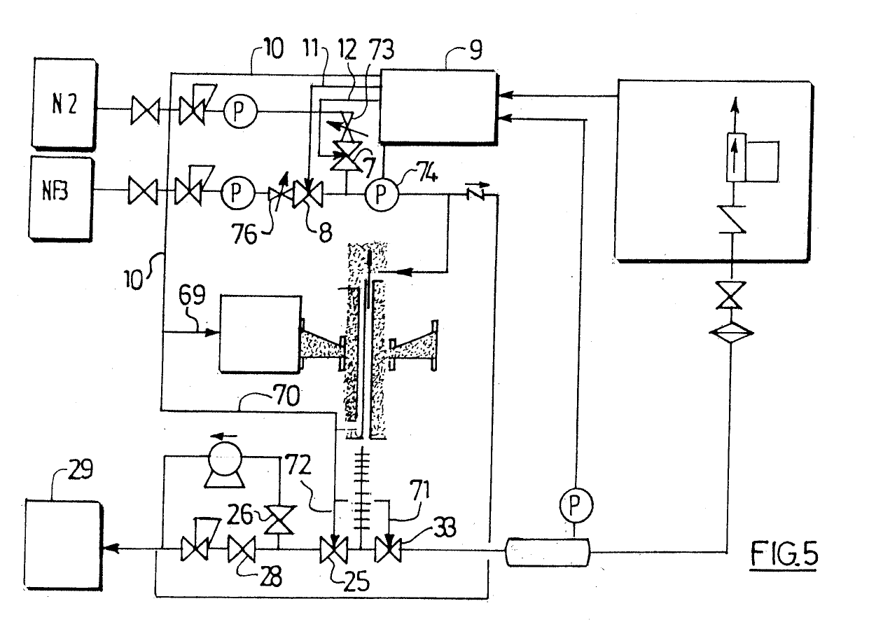

FIG. 5, an alternative of FIG. 4, illustrating the switch to fluorine production position;

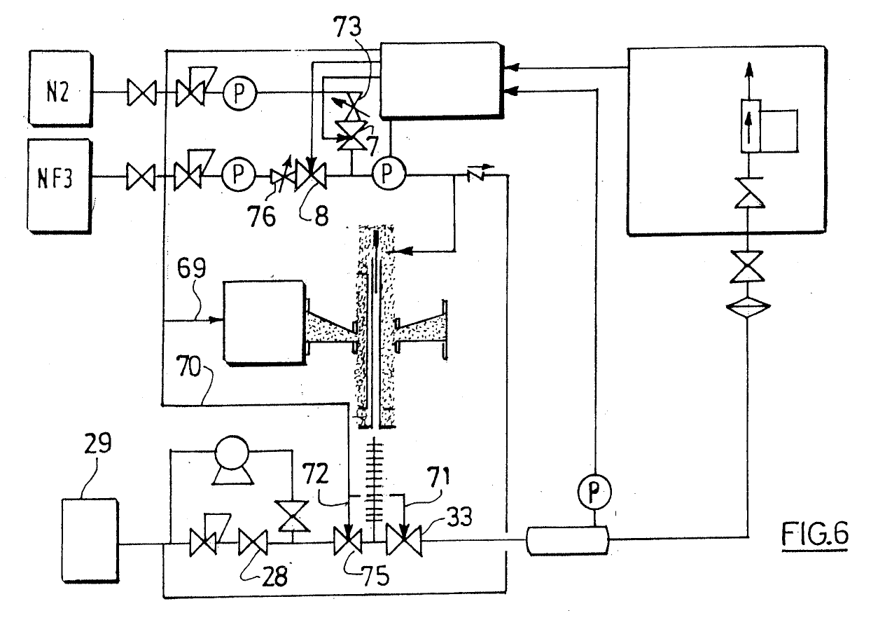

FIG. 6, an alternative of FIG. 4, illustrating operation during the supply of fluorine;

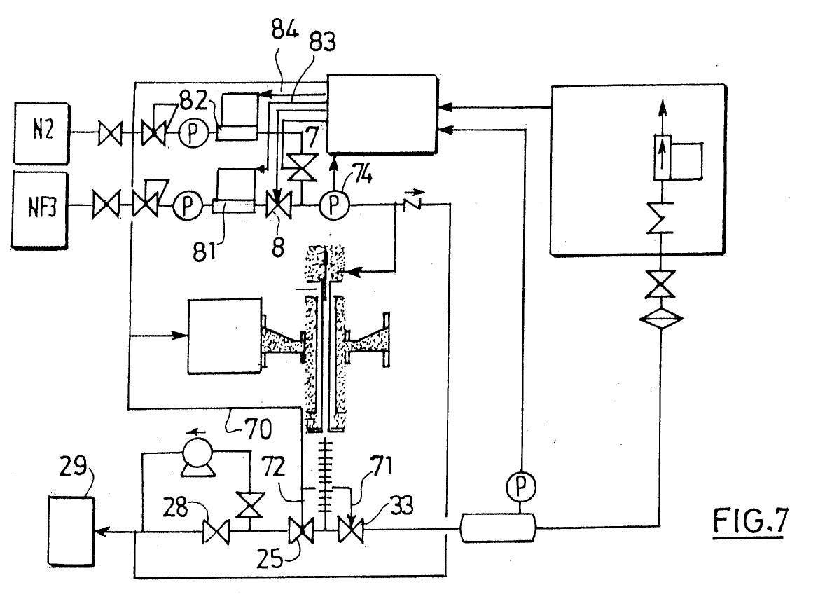

FIG. 7, an alternative of FIG. 4, in which the calibrated restrictions have been replaced by mass flow controllers.

According to a first alternative of the invention, the means for decomposing (cracking) the NF₃ molecule consists of a plasma generator in which the nitrogen trifluoride NF₃ is injected either pure or in a mixture with one or more preferably inert and preferably plasma generating gases such as nitrogen, argon, helium, neon, krypton and/or xenon. CO₂ and/or NO may be suitable in certain cases.

The characteristic feature of the plasma generator of the invention is to generate molecular fluorine F₂ by cracking NF₃ which is essentially the case when the pressure of the plasma is close to atmospheric pressure. The most appropriate plasmas for implementing the invention are high electron density plasmas such as microwave plasmas, particularly surface wave plasmas, inductively coupled plasmas (ICP) and electric arc plasmas, preferably corona and dielectric barrier discharge (DBD) plasmas. This is because a sufficient number of active species must be present in the plasma to dissociate the high NF₃ concentrations.

The high density discharges maintained at atmospheric pressure are not very far from thermodynamic equilibrium. This means that the temperature of the heavy species (neutral and ions) is typically not lower than one-tenth of the electron temperature. Hence the gas in the discharge may be very hot, up to 7000° C. Heat transfer mechanisms accordingly play a non-negligible role in the mechanisms of chemical conversion of nitrogen trifluoride. The very high temperature in the discharge has the effect of very rapidly shifting the system into the final state provided by thermodynamics. The hot electrons outside the equilibrium themselves reinforce this effect. The gas temperature may, for example, be measured by optical emission spectrometry. It is found that in the plasma (see tables below), NF₃ is totally dissociated and is present in the form of atomic fluorine.

A very rapid cooling of the gas (chemical quenching) can prevent the reverse reactions and the reformation of NF₃. The evolution of the system is accordingly very highly irreversible, that is, the gas is at all times far from a state of virtual thermodynamic equilibrium. Preferably, the characteristic cooling time must be much shorter than the reverse time of the kinetic coefficient of the reverse reaction culminating in the reformation of NF₃.

Atomic fluorine is not a stable species at ambient temperature. During the quench, the recombination of atomic fluorine essentially occurs by volume interactions because the prevailing pressure is atmospheric. The two-substance reaction yielding molecular fluorine is then far more probable than the reaction reproducing NF₃.

Thus, to implement an effective method for producing F₂ from NF₃ according to the invention, the gas mixture issuing from the plasma should preferably be sent as rapidly as possible to highly efficient cooling means, capable of very rapidly lowering the temperature of the gas below the point which NF₃ can coexist with its decomposition products. This prevents the reformation of nitrogen trifluoride from the decomposition products. To carry out this rapid cooling, a heat exchanger is preferably used (sometimes, for low temperature plasmas, these means for cooling the gas mixture can simply consist of the (normally cooled) walls of the vessel receiving this mixture issuing from the plasma). The characteristics of the heat exchanger (dimensions, heat exchange structure) must be such that the characteristic cooling time is significantly shorter than the reverse time of the kinetic coefficient of the reverse reaction leading to the reformation of NF₃. The cooling means may, for example, consist of a gas-liquid heat exchanger using cold water in a closed circuit from the utilities of the semiconductor production plant, with for example a coil or tube bundle architecture (tubes preferably parallel or substantially parallel) in order to maximize the heat exchange area. This heat exchanger is mounted so that its gas inlet is located as close as possible to the downstream limit of the plasma zone.

Any type of the high density plasma can be used to implement the invention, preferably operating close to atmospheric pressure (or higher pressure), and particularly atmospheric pressure microwave plasma sources designed by the Applicant and described particularly in patents EP-A-0 820 801 and EP-A-1 332 511 and also in U.S. Pat. Nos. 5,961,786 and 6,290,918. In general, plasmas close to (or not too far from) thermodynamic equilibrium are preferred.

An apparatus which may be appropriate can also consist of the plasma source described in U.S. Pat. No. 5,418,430 or WO 03/0411111.

The considerable advantage of the inventive method is the fact that pure fluorine is not generally used for cleaning, impermeabilization or other operations. It is generally used in a mixture with nitrogen. As it so happens, the decomposition using a plasma (or thermally) of nitrogen trifluoride NF₃ leads to the formation by cracking (particularly when all the NF₃ molecules are cracked) of three molecules of fluorine F₂ per molecule of nitrogen starting with two molecules of NF₃: the mixture thereby created hence comprises a maximum of 75 mol % of fluorine and 25 mol % of nitrogen. According to the invention and the type of mixture to be obtained, this mixture can be diluted with nitrogen and/or with any other gas, thereby producing gas mixtures containing 75 mol % of fluorine and 25 mol % of nitrogen up to mixtures containing a few ppm of fluorine in pure nitrogen or mixed with other inert, reducing (H₂, etc.) or oxidizing (O, O₃, etc.) gases. Other gases containing fluorine (SF₆, etc.) or not can be added before cracking the molecules of fluorine-containing gas, or after cracking, before and/or after rapid cooling of the mixture formed, but also to carry out this rapid cooling or quenching (for this purpose, it is possible to inject cold gas—nitrogen, argon, helium, etc. up to −180° C. or even use a countercurrent cold liquid spray, preferably of the gas to be cooled).

In microelectronic applications (for example, cleaning of semiconductor production chambers) these start with NF₃ gas of “electronic” grade, that is having a purity at least equal to that demanded by semiconductor production and whereof the specifications can be found in the road map published by SEMI every year.

Other applications can start with NF₃, generally of lower grade.

The molecular fluorine produced is generally delivered to the user apparatus at low temperature and preferably at ambient temperature. Thus, the heat exchanger placed at the plasma exit for the chemical quenching of the gas may also have the function of cooling the mixture to a temperature of below 50° C., for example, this gas mixture then being storable in a buffer tank or used immediately as explained below.

After using the more or less dilute mixture (using for example mixing means which receive the nitrogen/fluorine mixture issuing from the plasma reactor and also the dilution gas such as nitrogen and/or any other gas, to deliver a gas mixture containing less than 75 mol % of F₂), the mixture is recovered at the outlet of the user apparatus with the cleaning byproducts, the mixture being sent to destruction/scrubber means, either wet (passage through a caustic soda or potash solution, for example), or dry (reactive adsorption on granules of soda lime or other alkaline adsorbents), or over plasma destruction means as described above, in which a source of oxidant (oxygen, ozone, steam, etc.) is provided, the mixture of fluorine and oxidant after passage through the plasma generating one or more compounds of the HF, COF₂, NOF, etc. type, which are themselves destroyed by the dry or wet destruction/scrubber means described above.

In an alternative, the gas can be stored after use in a buffer tank.

Obviously, according to a further alternative of the invention, the generator of the invention can be coupled with another plasma system, as described above, which is connected in line with the outlet of the apparatus using the fluorine-containing gas. Plasma systems of this type are widely described in the literature and are designed to destroy molecules of the PFC/HFC type and particularly fluorine F₂, in order then, in the presence of an oxidant, steam, etc., to create effluents such as HF or others which are then absorbed in water scrubbing or other systems.

Various alternatives of the invention will now be described in conjunction with the figures.

Several configurations are suitable for implementing this NF₃ cracking system to supply a process unit with fluorine, such as, for example, a cleaning unit or a semiconductor production tool, particularly a “CVD” type deposition chamber, and also, for example, fluorination equipment for polymer plastic tanks (PVC, etc.) to make them impermeable by creating a fluorine-containing layer on the surface of the polymer, making the latter impervious to hydrocarbon vapors.

The choice essentially depends on the instantaneous and average flow rate required, the number of units to be supplied, and the supply pressure required.

The simplest configuration is that in which the instantaneous F₂ demand is lower than the instantaneous NF₃ cracking capacity.

In this case, the best implementation consists in maintaining the plasma ignited permanently under an N₂ flow (in low power mode), and switching from this standby mode (FIG. 1) to a load mode (FIGS. 2 and 3 or FIGS. 4 to 6, or FIG. 7, according to the control modes) by adding NF₃ to the nitrogen stream or by substituting the nitrogen stream completely or partially with NF₃.

The condition for switching from standby mode (FIG. 1) to cracking mode (FIGS. 2 and 3) can be triggered either by a demand produced from equipment, or by a pressure drop in the distribution line due to the use of gas by the user apparatus. In order to impart greater flexibility in terms of response time for switching from one mode to the other, this distribution line can be equipped with a buffer tank. The choice of the trigger method essentially depends on the distance between the user apparatus and the generator, the trigger based on the line pressure being preferably recommended when the distribution system is located far from the apparatus (the gas in the line being sufficient to perform the buffer function).

FIG. 1 shows an exemplary embodiment of the invention with a plasma source as described in U.S. Pat. No. 5,965,786 and U.S. Pat. No. 6,290,918.

In this figure, the same elements as those in the subsequent figures have the same reference numerals, or are shown in the subsequent figures in the same way as in FIG. 1 without the use of a reference numeral.

The plasma source of the invention comprises a unit 1 equipped with an inner dielectric tube 22 into which the NF₃ gas (pure or in a mixture) is introduced via the opening 4 located at the top of the tube, close to the plasma priming electrode 3 connected to a high voltage generator, not shown in the figure, to create a spark in the tube. The unit 1 of the dielectric tube 21 passing through a waveguide 2 in its thinner central part 49, which expands on each side at 48 and 47, the end 47 being connected to the outlet of the magnetron 21 which generates the microwaves necessary to create the plasma in the tube 22 at the level of the guide 49, and the end 48 being connected to a mobile short-circuit piston (not shown) forming an adjustable impedance matcher to prevent the reflection of microwave power to the magnetron. The waveguide field applicator serves to concentrate the microwave energy at the thinner guide section 49 and to launch a progressive surface wave which propagates on either side of the guide, along the dielectric tube, gradually giving up its energy to the plasma to maintain the latter.

The heat exchanger 24 is located as close as possible to the outlet of the discharge tube 23. Preferably, the discharge tube is just sufficiently long so that the distance from the downstream end of the discharge zone to the outlet 23 of the tube is optionally minimal. This is because over said distance, the cooling of the gas is generally not sufficient (except in the case of “cold” plasmas) to at least initiate the quenching, and a certain quantity of NF₃ could be reformed, particularly in the case of a small-diameter tube in which the relative proportion of surface recombination is increased. The minimum value of the distance between the downstream end of the discharge zone and the tube outlet 23 is imposed by the need to prevent the surface wave accompanying the plasma from being reflected on the generally metal parts which constitute the fluid connections at the end of the discharge tube. If not, this could cause the appearance of steady-state modes for the surface wave, which is detrimental to reliability by reinforcing the energy density at the wave peaks, and would degrade the energy coupling characteristics of the plasma source by imparting a partially resonant character to the system.

The apparatus comprises a nitrogen gas source 20 connected to the valve 18, the controlled valve 16 and the pressure gauge 14 at the valve 7 connected by the control line 12 to the logic controller 9 and to the calibrated orifice 46 upstream of the valve 6. The outlet of the valves 6 and 7 is connected to the line 5 which conveys the gas mixture (or a pure gas) to the inlet 4 and to the outlet of the controlled valve 8 (shown by the electrical control line 11 also connected to the logic controller 9), whereof the inlet is connected to the pressure detector 13, to the controlled valve 15, to the valve 17 itself placed at the outlet of the NF₃ gas source 19.

The logic controller 9 also controls the operation of the magnetron microwave generator 21 by the electrical line 10.

The outlet 23 of the ceramic tube 22 is connected via a heat exchanger 24 to the inlet of valves 5 and 33. The valve 25 serves to send the gas issuing from the heat exchanger 24 to the treatment circuit 29, via the valve 28 and the calibrated orifice 45 or via the valve 26 and the pump 27 whereof the outlet is connected at 30 to the outlet of the calibrated orifice 45.

A line 44 is used to send the gas directly via the calibrated valve 32 into the line 5 when an overpressure thereof exists, directly to the point 30 and thus to the treatment device 29.

The outlet of the valve 33 is connected to the buffer tank (optional) 35 whereof the outlet, via the line 39 feeds the pressure reducer/valve unit 40 and the apparatus 42, via the mass flow controller 41. The line 38 transmits the electrical data from the apparatus 42 (associated with the need for F₂ gas generated by the apparatus 1) while the gas pressure in the buffer tank 35 is measured by the pressure probe 36 and the pressure data (in the form of an electrical signal) are transmitted by the line 37 to the logic controller 9.

The various types of operation are now explained in conjunction with FIGS. 1 to 7 which all show the same apparatus, optionally with some alternatives, with color indications of the valves indicating whether they are closed or open. Thus in FIG. 1, the inventive apparatus is in operation in “inactive” mode, that is in electrical operation under reduced power supply voltage (1 kW) without generating fluorine gas. For this purpose, the valves 6, 8, 26 and 33 are closed (black), the other valves are open (white). Accordingly, only the nitrogen gas can flow via the valve 7 (opened by the controller 9) to pass through the dielectric tube 22, in order to maintain the plasma under low power (1 kW), plasma using nitrogen only, the treated gas being removed via 25, 28 and 45 to the device 29.

FIG. 2 shows the same apparatus as FIG. 1, but in operation to generate fluorine exclusively from NF₃. For this purpose, the valves 6 and 7 are closed (black) and the valve 8 is open. In order to dilute the gas generated by the plasma with nitrogen, it suffices to avoid completely cutting off the nitrogen feed (valves 6, 7) when opening the valve 8 (using the controller 9). The nitrogen trifluoride is therefore cracked into a mixture of F₂+N₂ (possibly with residual NF₃). The valve 25 being closed, while the valve 33 is open, the buffer tank 35 is filled and the apparatus 42 is fed if the electrical signals received via 38 do not indicate the closure of the valve 40.

The condition for switching from standby mode to cracking mode can be triggered either by a demand produced from the equipment, or by a pressure drop in the distribution line due to the use of gas by the “tool”. To impart greater flexibility in terms of response time to switch from one mode to the other, this distribution line can be equipped with a buffer tank. The choice of the trigger method essentially depends on the distance between the process unit using the fluorine and the generator, and the trigger based on the pressure in the line is preferably recommended when the distribution system is located far from the process equipment (the gas present in the line being sufficient to perform the buffer function).

In the example described above, the NF₃ is used pure, making it possible to convert 100% of the N₂ stream in standby mode to 100% NF₃ in cracking mode. This also makes it possible to work without using flow control, but exclusively pressure controls on the NF₃ and N₂ upstream of the generator. At the generator outlet, a vacuuming line permits the first ignition of the plasma (by the pump, procedure not shown here), as well as the purge of the F₂ initially generated, before switching to the process line).

FIG. 3 shows the same schematic operation (distribution of fluorine-containing gases) of the inventive apparatus with three apparatus 50, 51, 52 connected in parallel from the VMB 60 distribution system fed by the line 39, connected to the line 64 which distributes the gas via the pressure reducer/valve units respectively 61, 62 and 63 to the apparatus 52, 51 and 50 respectively.

FIG. 4 is an alternative of FIG. 1 in which the calibrated restrictions 73 and 76 are placed upstream of the valves 7 and 8 respectively, a pressure detector 74 being placed in the line 5 downstream of the outlet of the valves 7 and 8, detector 74 which transmits a pressure measurement via the electrical line 75 to the controller 9.

FIG. 5 shows a switching step between the “inactive” step (FIG. 4) and the fluorine supply step (FIG. 6). In this step, compared with FIG. 4, valve 8 has been opened, allowing the feed of the tube 22 with N₂+NF₃ mixture (and then to cut off the N₂ if desired).

FIG. 5 illustrates, after stabilization, the feed of the buffer tank (valve 25 closed and valve 33 open) and the sending of the fluorine to the apparatus 42.

One can thereby generate N₂/F₂ mixtures based on control of the flow rates and not of the feed pressures. In this case, the generator is fed with a fixed or variable mixture of nitrogen and NF₃. This mixture can be prepared by using calibrated orifices or any other flow obstruction such as needle valves or capillary tubes (fixed NF₃/N₂ ratio), or mass flow controllers (variable ratio), or a combination of both. The servocontrol of the total flow rate passing through the generator can be achieved in various ways, as described below, but not limited thereto:

Use of flow obstructions: in standby mode, the nitrogen line alone feeds the generator which operates at reduced power. Upon demand produced or pressure drop in the line/buffer, the generator power is increased and the NF₃ line is opened to generate an NF₃/N₂ mixture with a preset concentration. The gas initially generated is first removed to an exhaust line for stabilizing flow rates and concentrations, and the gas generated is then sent to the process line, optionally via a buffer tank. When product demand stops, or when the pressure in the buffer tank line reaches a threshold value, the gas generated is again sent to the exhaust and the system is restored to standby mode (closure of NF₃ line, etc.). The advantage of this method is reduced cost, but it entails frequent mode switchings and creates pressure variations in the generator, which may disturb its operation.

One solution may consist in generating a flow rate higher than needed by the user process equipment, whereof the excess is constantly removed by the exhaust line. In this case, an upstream pressure controller serves to maintain a sufficient pressure in the process line.

FIG. 7 is an alternative of FIG. 6 (in operation) replacing the calibrated restrictions 73 and 76 by mass flow controllers (respectively 82 and 81), electrically controlled via the lines 84 and 83 by the controller 9.

By using the mass flow controllers instead of flow obstructions, it is possible to servocontrol the total flowrate (at constant N₂/NF₃ ratio) to the pressure in the line in order to maintain a constant pressure. In this case, the flow rate generated is adjusted to the rate required by the equipment, thereby avoiding mode switching during the use of F₂ by the equipment. The same control system can be applied similarly in the case of a controller by flow obstruction.

In its version using a plasma, the generator of the invention can generally be equipped with any system capable of generating a high density plasma at atmospheric pressure, that is, in fact a plasma operating between about 10⁴ pascals and 10⁶ pascals (or more) and having an electron density of between 10¹² and 10¹⁵ cm⁻³, for example between 10¹³ and 10¹⁴ cm⁻³.

In fact, on the one hand, it has been found that in high density plasmas for obtaining good NF₃ decomposition kinetics and high efficiency, when operating at low pressures, about 10² pascals and as described for example in U.S. Pat. No. 5,812,403, atomic fluorine is first mainly generated and, if not used as such to chemically attack the solid films deposited and thereby clean the walls of the chamber of the CVD unit maintained under vacuum, recombines on the clean solid surfaces and to a lesser degree in volume to reproduce molecular fluorine. Hence there is no advantage in passing through this succession of more complex steps requiring a vacuum holding installation to achieve the same result at indicated in the invention, i.e. molecular fluorine delivered at atmospheric pressure.

Furthermore, the other types of discharge operating at atmospheric pressure, such as corona vapor discharges or DBD, are less appropriate for implementing the invention. The physical properties of these discharges are very different from those considered above. They generally have inhomogeneous structures with streamer zones, in which the electron density may be about 10¹¹ electrons cm³, the density in the rest of the volume not exceeding a few 10⁹ electrons cm⁻³. Moreover, these discharges are generally maintained in pulsed mode so that long periods also exist when the medium contains no high energy electrons. This means that these discharges are ineffective for dissociating a high percentage of NF₃ for the high concentrations considered, for example about 1 to 10 vol %. Besides, the reformation of NF₃ would very probably occur in the zones between streamers and during idle periods between excitation pulses, because the gas is both at atmospheric pressure and substantially at ambient temperature. In consequence, to implement the invention using atmospheric discharges called “cold” discharges, the plasma source would have to be a generally much larger size than a high density source in partial or complete local thermodynamic equilibrium for the same performance.

After using the fluorine in the user apparatus, the waste gases, which may still contain fluorine, must be destroyed either by passage through a wet or dry absorption system (wet scrubber or dry scrubber) or even previously in a plasma system, for example at atmospheric pressure, as described above, the gas being injected into the plasma preferably with water vapor or an oxidizing gas before the gases leaving the plasma are treated in a wet scrubber system.

### EXEMPLARY EMBODIMENTS

### Example 1

A mixture of NF₃ and nitrogen (comprising 1.3 vol % to 18.0 vol % of NF₃, is sent to an apparatus as described in EP-A-0 820 801 (the total flow rate of gas expressed in liters/minute (SLM) is 20, the dielectric tube having a diameter of 8 mm). The power of the magnetron can be varied from 2500 to 4000 W. The results obtained concerning the decomposition of the NF₃ and the production of F₂ are given below. The FT-IR measurements give the residual NF₃ concentration and, by difference, that of F₂, the UV measurements being real direct measurements of this F₂ concentration. The term DRE represents:

$$D R E \% = 100 ( 1 - \frac{{( {NF}_{3} )}_{out}}{{( {NF}_{3} )}_{i n}} )$$

where (NF₃)ᵢₙ=incoming NF₃ concentration, (NF₃)ₒᵤₜ=outgoing NF₃ concentration. F

The “influent” term in Table 1 below describes the inlet flow rate in the plasma (in liters/min−slm) and the volumetric concentration of NF₃ (in a mixture of NF₃ and nitrogen).

TABLE 1

| Influent | | | | | | | | | | | | | | | | | | |
|---|---|---|---|---|---|---|---|---|---|---|---|---|---|---|---|---|---|---|
| Total | | 2500 W | | | | 3000 W | | | | 3500 W | | | | | 4000 W | | | Magnetron |
| flow | | FT-IR | | | UV | FT-IR | | | UV | FT-IR | | | UV | FT-IR | | | UV | Power |
| rate | | DRE | F2 | | | DRE | F2 | | | DRE | F2 | | | DRE | F2 | | | Typical |
| (SLM) | NF₃(%) | (%) | SLM | % | | (%) | SLM | % | | (%) | SLM | | | (%) | SLM | % | | Analyses |
| 20 | 1.3 | 92 | 0.4 | 1.8 | 1.9 | 97 | 0.4 | 1.9 | 1.9 | 98 | 0.4 | 1.9 | 1.9 | | | | | Concentration |
| | 4.3 | 78 | 1.0 | 4.9 | 4.9 | 87 | 1.2 | 5.4 | 5.5 | 97 | 1.3 | 6.0 | 6.1 | | | | | of products |
| | 8.9 | 68 | 1.8 | 8.6 | 9.5 | 72 | 2.0 | 9.1 | 11.2 | 85 | 2.3 | 10.7 | 13.7 | 92 | 2.5 | 11.3 | 14.8 | |
| | 18.5 | 65 | 3.5 | 15.0 | 12.6 | 73 | 3.9 | 16.4 | 13.4 | 79 | 4.3 | 17.8 | 16.2 | 87 | 4.7 | 19.4 | 19.0 | |

### Example II: in this Example II, only the diameter of the dielectric tube is changed (4 mm instead of 8 mm) compared with example I.

TABLE II

| Mixer Inlet | | | Mixer Outlet | | | | | |
|---|---|---|---|---|---|---|---|---|
| N₂ | 3NF₃ | | NF₃ | DRE | F₂ | | UV | Magnetron |
| SLM | SLM | % | % | % | % | SLM | % | Power |
| 5.5 | 0.5 | 8.3 | 0.1 | 99.2 | 11.4 | 0.7 | 9.5 | 3500 W |
| 5 | 1 | 16.7 | 0.1 | 99.0 | 21.2 | 1.5 | 17.5 | |
| 4.5 | 1.5 | 25.0 | 0.3 | 98.3 | 29.5 | 2.2 | 24.6 | |
| 4 | 2 | 33.3 | 0.7 | 97.3 | 36.5 | 2.9 | 31.2 | |
| 3.5 | 2 | 36.4 | 1.1 | 96.0 | 38.4 | 2.9 | 36.9 | |
| 3 | 2 | 40.0 | 1.3 | 95.4 | 40.9 | 2.9 | 39.6 | |
| 2 | 2 | 50.0 | 3.3 | 90.1 | 45.1 | 2.7 | 43.2 | |
| 2 | 2 | 50.0 | 1.7 | 94.9 | 47.4 | 2.8 | 45.3 | 4000 W |
| 2 | 2 | 50.0 | 0.7 | 97.9 | 49.0 | 2.9 | 46.5 | 4500 W |

The results of examples 1 and 2 above show in particular a very low residual rate of undestroyed (uncracked) NF₃.

The generator of the invention in its thermal version comprises three elements, an oven heated to an adjustable temperature in order to obtain an appropriate decomposition kinetics, preferably above 500° C., and two heat exchangers, one heating the gas to be decomposed entering the oven in countercurrent flow to the decomposed gases leaving the oven, the other on the decomposed gas circuit serves to adjust the temperature of the cleaning gas (the process being exothermic), before its injection into the chamber to be cleaned. In both configurations described, it is possible to prepare a compact unit suitable for installation, at the use point, and to supply a nitrogen/fluorine mixture at a flow rate adapted to the cleaning process of a wafer oven. Moreover, this molecular fluorine generator raises no complex safety problems on a semiconductor production site where the source product, NF₃, is already generally stored in substantial quantities. Furthermore, since the decomposition process is simple, it is easy to control and, in consequence, not liable to adversely affect the load factor of the oven to be cleaned.

In general, as in all cases in which a plasma is used, the plasma is generally first ignited by initially injecting a plasma generating gas (for example, argon or nitrogen), before then injecting the gas to be cracked (NF₃ here) alone or in a mixture (with the gases mentioned above), while maintaining, reducing the flow rate or totally cutting off the injection of initial plasma generating gas.

1-19. (canceled)

20. A method for preparing a gas or gas mixture containing molecular fluorine from a gas or gas mixture derived from fluorine, wherein the fluorine-containing gas or gas mixture, particularly nitrogen trifluoride NF₃, is decomposed by passage through a hot high electron density plasma, a plasma generated at atmospheric pressure or close to atmospheric pressure, in order to obtain a maximum temperature Tₘₐₓ higher than 2000 K of the heavy species in the plasma, the mixture of the various species represented in the plasma then being cooled to a temperature Tₕ, then rapidly cooled between Tₕ and T_{b}, Tₕ and T_{b} being two temperatures determined experimentally according to the fluorine-containing gas or gas mixture, Tₕ being the temperature from which the molecules of gas or gas mixture initially injected into the plasma can begin to reform from their dissociation fragments and T_{b} being the temperature at which over 90% of the fluorine atoms produced by the dissociation in the plasma have recombined, in order to obtain a gas mixture containing molecular fluorine F₂.

21. The method of claim 20, wherein the maximum temperature of the heavy species (ions and neutral) in the discharge generating the plasma is between 3000 K and 10 000 K.

22. The method of claim 21, wherein the electron density of the plasma is higher than 10¹² electrons/cm³, preferably between 10¹² and 10¹⁵ electrons/cm³.

23. The method of claim 22, wherein the rapid cooling time between the temperatures Tₕ and T_{b} is equal to 5×10⁻² s or lower to prevent a substantial reformation of the initial species and to promote the formation of fluorine molecules F₂.

24. The method of claim 23, wherein the rapid cooling time is shorter than 10⁻², preferably shorter than 5×10⁻³ s.

25. The method of claim 20, wherein the fluorine-containing gas is nitrogen trifluoride NF₃, Tₕ being about 1200 K and T_{b} being about 800 K.

26. The method of claim 20, wherein the plasma is a plasma close to thermodynamic equilibrium and particularly a plasma generated by radiofrequency waves in inductively coupled mode or microwaves.

27. The method of claim 20, wherein the plasma is generated at atmospheric pressure or close to atmospheric pressure, varying between 10⁴ and 10⁶ pascals.

28. The method of claim 20, wherein the fluorine-containing gas or gas mixture is mixed with a first preferably inert gas, prior to the cracking step.

29. The method of claim 20, wherein the gas or gas mixture is diluted with a second gas, particularly an inert gas, during or after the cracking of the fluorine-containing gas or gas mixture.

30. The method of claim 29, wherein the temperature of the second gas is such that it serves to carry out at least partially the rapid cooling step that may be necessary to promote the formation of molecular fluorine.

31. The method of claim 20, wherein after cooling, the gas mixture is mixed with a third preferably inert gas.

32. The method of claim 20, wherein the first, second, and/or third gases are selected from nitrogen, argon, helium, krypton, xenon, CO₂, CO, NO, hydrogen, alone or in mixtures thereof.

33. The method of claim 20, wherein the gas mixture containing molecular fluorine comprises 75 mol % to 1 ppm of molecular fluorine F₂.

34. The method of claim 20, wherein the gas mixture containing molecular fluorine is contacted with a surface or with a volume.

35. The method of claim 34, wherein the surface or volume is made from metal, polymer and/or dielectric material.

36. A fluorine-containing gas generator delivering a gas containing molecular fluorine, wherein it comprises a source of gaseous nitrogen trifluoride NF₃, means for generating a hot high electron density plasma to decompose the fluorine-containing gas molecules and to generate a plasma at a maximum temperature of the heavy, neutral and ionic species Tₘₐₓ above 2000 K, means for cooling the gas mixture produced by this decomposition, and means for recovering the gas mixture containing the molecules of fluorine F₂, cooled to a temperature below T_{b}.

37. The generator of claim 36, wherein it also comprises an inert gas source such as a source of nitrogen, argon, helium, and/or mixtures thereof.

38. The generator of claim 36, wherein it comprises means for mixing the gas mixture with a second gas such as an inert gas or hydrofluoric acid gas.
